(19) United States
(12) Patent Application Publication
(10) Pub. No.: US 2018/0039106 A1
(43) Pub. Date: Feb. 8, 2018

(54) ELECTRONIC LIQUID CRYSTAL LENSES

(71) Applicant: Microsoft Technology Licensing, LLC, Redmond, WA (US)

(72) Inventor: Vicente Calvo Alonso, Piispanristi (FI)

(73) Assignee: Microsoft Technology Licensing, LLC, Redmond, WA (US)

(21) Appl. No.: 15/226,012

(22) Filed: Aug. 2, 2016

(51) Int. Cl. G02F 1/137; G09G 3/36; G02F 1/1339; G02B 3/12; G02F 1/1343

(52) U.S. Cl. CPC G02F 1/137; G02B 3/12; G02F 1/134309; G02F 1/1339; G09G 3/36

(57) ABSTRACT

Described herein are electronic liquid crystal lenses for use in electronic devices, and associated devices, systems, and methods. The disclosed lenses can be positioned external to an electronic display component or image receiving component of an electronic device to manipulate the light passing through the lens in a desirable manner. The disclosed lenses include liquid crystal material that is adjustably controllable using individually controlled linear electrodes to produce a variable refractive index across the liquid crystal material and achieve a desired lensing effect on light passing through the lens.

### FIELD

This application is related to electronic liquid crystal lenses, and in particular to electronic liquid crystal lenses for electronic display devices.

### BACKGROUND

It is often desirable to manipulate the apparent edge of a display so that it appears closer to an edge of a device. For example, electronic display devices may include an undesirably wide deadband area at the lateral edge of a device, limiting the display area that can be produced within the given confines of the device frame and producing a dark unusable strip along the edge of the device. Typically, a specially shaped cover window is positioned over the display device to bend the light emitted at the lateral edge of the display device so that the edge of the displayed image appears closer to the lateral edge of the device frame and the deadband region appears smaller. To accomplish this, the cover window typically includes a non-planar surface at its lateral edge, such as a curved or chamfered surface near the lateral end of the lens. The non-planar surface causes a lensing effect by refracting the light passing through that portion of the lens, causing the light to appear to be coming from a location closer to the edge of the frame of the device that where it really is emitted from at the edge of the display device.

However, such curved or chamfered cover windows require an undesirably large thickness in order to include the desired degree of curvature or chamfering on the lens surfaces. They are also fixed is shape and provide a static lensing effect that cannot be changed without removing and replacing the whole lens. This added thickness causes the overall thickness of the device to be increased and/or reduces that available space in the device for other desirable components. Therefore, there exists an opportunity to improve in technologies relating to lenses for manipulating the display of images from electronic devices such that a desired lensing effect can be achieve without the lens being unduly thick and static.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described herein are electronic liquid crystal lenses for use in electronic devices, and associated devices, systems, and methods. The disclosed lenses can be positioned external to an electronic display component or image receiving component of an electronic device to manipulate the light passing through the lens in a desirable manner. The disclosed lenses include liquid crystal material that is adjustably controllable using electrodes to control the refractive index of the liquid crystal material and achieve a desired lensing effect on light passing through the lens.

An exemplary electronic liquid crystal lens for use in an electronic device comprises an outer transparent substrate layer, an inner transparent substrate layer, a layer of liquid crystal material arranged between the inner and outer transparent substrate layers, and linear electrodes arranged between the inner and outer transparent substrate layers and along the layer of liquid crystal material, wherein the linear electrodes are controllable to achieve a lensing effect through the lens by generating a variable refractive index in the layer of liquid crystal material.

In some embodiments, the liquid crystal lens further comprises a planar electrode positioned between the inner and outer transparent substrate layers and on a side of the layer of liquid crystal material opposite from the linear electrodes. In some embodiments, the linear electrodes are arranged parallel to one another in a common plane, and the layer of liquid crystal material is arranged parallel to the plane of the electrodes. In some embodiments, the linear electrodes are parallel with an edge of the outer transparent substrate layer. In some embodiments, each of the linear electrodes is individually controllable to control the refractive index of a corresponding linear row portion of the layer of liquid crystal material.

In some embodiments, the liquid crystal lens further comprises a sealing material creating a seal between the inner and outer transparent substrate layers along a lateral side of the lens to contain the liquid crystal material within the lens.

In some embodiments, the lensing effect is capable of causing light from a display image to pass through the outer transparent substrate layer closer to a lateral edge of the lens than where the light passes through the inner transparent substrate layer.

In some embodiments, the outer transparent substrate layer comprises a planar outer surface, a planar inner surface, planar lateral surfaces, and right-angled edges joining the lateral surfaces to the inner and outer surfaces, such that light is not refracted while passing through the outer transparent layer from the inner surface to the outer surface.

An exemplary electronic device comprises a frame, an electronic display mounted to the frame, and an electronic liquid crystal lens mounted external to the electronic display. The electronic liquid crystal lens comprises an outer transparent substrate layer, an inner transparent substrate layer, liquid crystal material arranged between the inner and outer transparent substrate layers, and linear electrodes arranged between the inner and outer transparent substrate layers and in contact with the liquid crystal material, wherein the linear electrodes are controllable to achieve a lensing effect through the lens by generating a variable refractive index in the liquid crystal material.

In some embodiments of the electronic device, the lens is configured to cause an edge of a display image generated by the electronic display to appear closer to an edge of the frame than an edge of the electronic display. In some embodiments, a lateral edge of the display device is spaced a first distance from a lateral edge of the frame, a lateral edge of the lens is spaced a second distance from the lateral edge of the frame, the second distance being smaller than the first distance, such that the lens makes a display image from the display device appear closer to the lateral edge of the frame. In some embodiments, the electronic display has a first lateral width between opposing lateral edges of the electronic display, the lens has a second lateral width between opposing lateral edges of the lens, the second width is larger than the first width, and the linear electrodes extend parallel to the lateral edges of the electronic display and parallel to the lateral edges of the lens. Each of the linear electrodes can be individually controllable to control the refractive index of a corresponding linear portion of the liquid crystal material.

An exemplary method of implementing a lensing effect comprises selecting an image to be displayed in a display area of an electronic device, determining a desired lensing effect to be applied to modify the appearance of the selected image based on a dimension of an electronic display device and/or a dimension of the display area, sending electronic signals to linear electrodes in a liquid crystal material layer to generate the determined lensing effect in the liquid crystal material layer by adjusting the refractive index of the portion of the liquid crystal material adjacent to each respective linear electrode, and displaying the selected image with the electronic display device such that the liquid crystal material layer modifies the image to produce a desired appearance of the image in the display area.

In some embodiments of this method, sending electronic signals to the linear electrodes comprises applying differing voltages to different ones of the linear electrodes to create a variable refractive index across a dimension of the liquid crystal material layer. In some embodiments, the lensing effect causes a deadband area of the electronic display to have a reduced apparent size in the display area. In some embodiments, the electronic signals cause one of the linear electrodes adjacent a lateral edge of the electronic display to cause liquid crystal molecules in the immediate vicinity to orient is such a way so as to refract light from the electronic display toward the lateral edge of the electronic display. The lensing effect can cause the image to appear to have a greater size than the electronic display.

In some method embodiments, the electronic device includes two adjacent display areas for two associated adjacent electronic displays, the electronic displays have adjacent deadbands, each electronic display has a respective liquid crystal material layer, and the method comprises causing the liquid crystal material layers to generate coordinated lensing effects that make simultaneously emitted images from the two electronic displays appear closer together so as to reduce the apparent width of the deadbands to a user.

As described herein, a variety of other features and advantages can be incorporated into the technologies as desired.

### BRIEF DESCRIPTION OF THE DRAWINGS

FIG. 1 shows an exemplary electronic device that includes a display area that extends close to an edge of the device.

FIG. 2. is a cross-sectional view of a portion of an electronic device that includes a display device and an exemplary liquid crystal lens mounted over the display device.

FIG. 3. is a cross-sectional view in elevation of an exemplary liquid crystal lens including individually controlled liquid crystal material portions positioned adjacent to linear electrodes.

FIG. 4. is a section view of the lens of FIG. 3 showing the linear electrodes arranged in a parallel pattern.

FIG. 5 shows an exemplary electronic device that includes two display areas that border each other, such as in a hinged multi-part electronic device.

FIG. 6 is a flow chart illustrating an exemplary method disclosed herein.

FIG. 7 illustrates an exemplary computing environment for a device implementing the disclosed technology.

FIG. 8 illustrates an exemplary mobile electronic device that can implement the disclosed technology.

FIG. 9 illustrates exemplary display devices that can be used with the disclosed technology in an exemplary cloud-based communication and computing environment.

### DETAILED DESCRIPTION

Described herein are electronic liquid crystal lenses for use in electronic devices, and associated devices, systems, and methods. The disclosed lenses can be mounted external to a display component or image receiving component of an electronic device to manipulate the light passing through the lens in a desirable manner. The disclosed lenses include liquid crystal material that is adjustably controllable using electrodes to control the refractive index of the liquid crystal material and achieve a desired lensing effect on light passing through the lens.

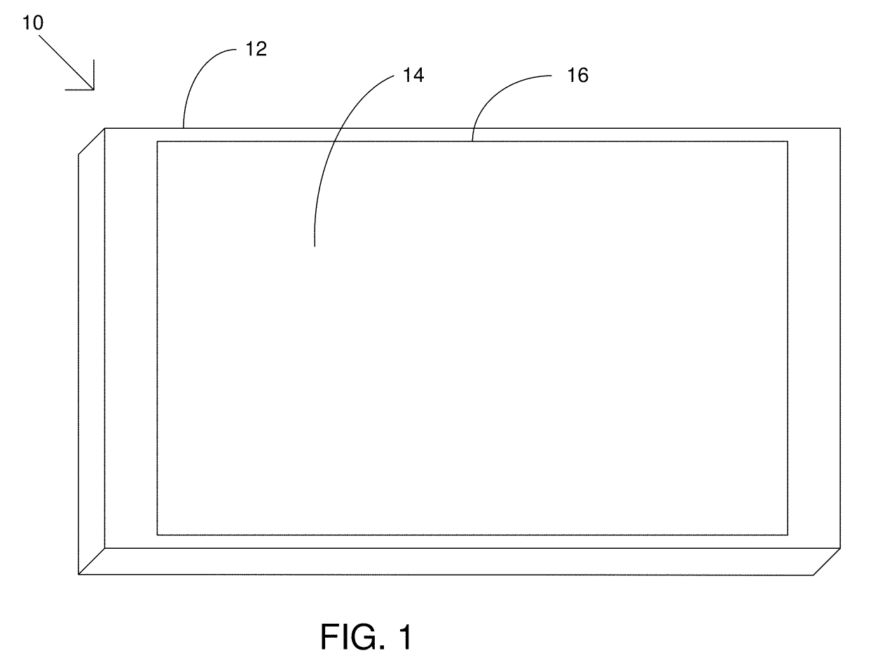

FIG. 1 is a perspective view of a representative electronic device 10 that includes a frame 12 and a display area 14. An edge 16 of the display area 14 is desirable close to the edge of the frame 12 to maximize the display area. In various embodiments, different edges and/or more than one edge of a display may desirably be located close to corresponding edges of the device, such as two opposing lateral sides of the display, or all four sides of a rectangular display.

The electronic devices described herein can be any type of electronic device, such as a handheld mobile computing device (e.g., smart phone), laptop, notebook, netbook, watch, bracelet, gaming controller, universal remote control, desktop monitor, other stationary display device, or other devices that include an electronic visual display or image receiving device.

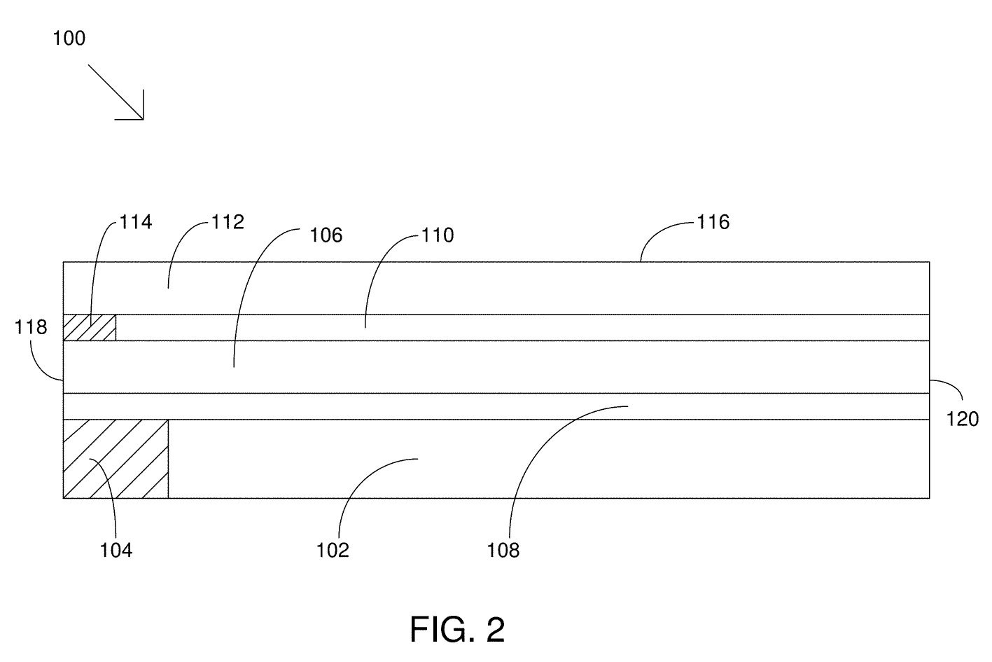

FIG. 2 shows a cross-sectional view of a portion of an exemplary electronic device 100 that includes a display device 102. In FIG. 2, the left side 118 of the drawing represents a lateral edge of the device 100 and the upper side 116 of the drawing represents an external direction and the lower side represents an internal direction of the device 100. The right hand side 120 of the drawing represents a portion of the device 100 toward the middle of the device in the side-to-side direction. As FIG. 2 is a simplified and schematic drawing, other components of the device 100 are omitted for clarity, and the components shown are not necessarily drawn to scale. Additional device components may underlie the display 102 and/or additional components may overlie the upper side 116. The device 100 can include rigid, non-transparent frame components, for example, that are positioned to the left of the lateral side 118.

In FIG. 2, a lens is positioned over the display 102, with the lens comprising an inner transparent substrate layer 106 (e.g., glass), and outer transparent substrate layer 112 (e.g., glass), and a liquid crystal material layer 110 positioned between the inner and outer transparent substrate layers. A sealing material 114 can be includes between the lateral edges of the substrate layers to seal in the liquid crystal material, and the seal material may be transparent, or partially or fully opaque. The lens can be coupled to the display 102 via a transparent adhesive layer 108 positioned between the inner substrate layer 106 and the display 102.

As shown in FIG. 2, the lateral portion of the display 102 can include a “deadband” region 104 that does not produce light. The deadband region 104 can serve a structural purpose or other non-light producing purpose that limits how close the light-producing portion of the display 102 can be to the lateral side 118 of the device 100. Without any lensing effect, the deadband region 104 would cause a user to see a dark and/or non-light-emitting strip along the edge of the device between the display area and the lateral edge of the device.

The disclosed liquid crystal lens technology can reduce the apparent thickness of the deadband region and increase the apparent size if the display area to the user. To accomplish this, the liquid crystal material layer 110 can be electronically manipulated to create a desired refraction index in the lens that causes light from the display 102 to bend as the light passes through the lens, creating a so-called “lensing effect” that changes the visual appearance of the image as viewed by a user. To reduce the apparent thickness of the deadband region 104, the liquid crystal layer 110 can be controlled electronically to refract light emitted from the portion of the display 102 adjacent to the deadband region toward the left in FIG. 2 so that the light exits the outer substrate layer 112 further to the left and/or with a trajectory that includes a leftward component. This can result in a user seeing the left portion of the display image when the user looks down through the left edge of the lens above the deadband region 104, rather than seeing a dark deadband that is not emitting light.

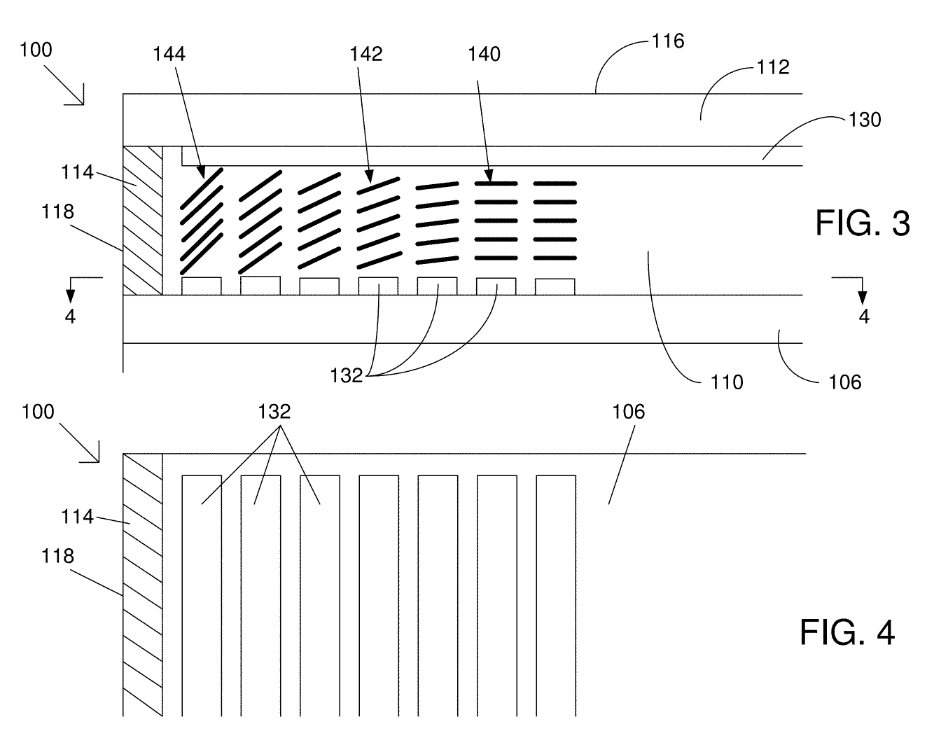

A more detailed illustration of lens portion of the device 100 is shown in FIGS. 3 and 4. FIG. 3 has a same view orientation as FIG. 2, but shows the liquid crystal layer 110 is greater detail. The liquid crystal layer 110 includes liquid crystal material (see portions 140, 142, 144) along with linear electrodes 132 positioned on one side and at least one opposing electrode 130 positioned on the opposite side of the liquid crystal layer 110. The linear electrodes 132 and the opposing electrode 130 may be reversed in other embodiments, with the linear electrodes being located external to the liquid crystal material. The opposing electrode 130 can act as a common ground or similar electrical component to complete a circuit from the linear electrodes 132 through the liquid crystal material. In alternative embodiments, the opposing electrode 130 can be substituted with a second set of linear electrodes, such as one for each of the linear electrodes 132.

FIG. 4 shows a top-down plan view of the linear electrodes 132 positioned on an external surface of the inner substrate layer 106 (view taken along section 4-4 illustrated in FIG. 3). As shown, a plurality of linear electrodes 132 are included in parallel arrangement to each other and parallel to the left-hand edge 118 of the device. The illustrated linear electrodes 132 are shown as having rectangular shapes, with even spacing between them. However, the linear electrodes may have non-rectangular shapes, and/or may have uneven widths, lengths, or spacing. In some embodiments, the linear electrodes separated by thin strips of electrically insulating material so that each electrode 132 is individually electrically isolated.

As shown in FIG. 3, each linear electrode 132 can individually cause an adjacent linear row portion of the liquid crystal material to behave in a different way and generate a variable local refractive index. For example, as shown in FIG. 3, the liquid crystal molecules 144 above the left-most linear electrode 132 are shown significantly tilted due to a specific electrical influence from the left-most linear electrode, producing a greater refractive index, whereas the liquid crystal molecules 142 are less tilted and the liquid crystal molecules 140 are not tilted and parallel to the underlying linear electrode, producing a reduced refractive index. In some embodiments, the voltage applied to each linear electrode 132 can correlate to the resulting effect on the liquid crystal molecules, with higher local applied voltages resulting in relatively greater local refractive indexes.

The illustrated orientation of the liquid crystal molecules in FIG. 3 is just one exemplary arrangement that can be generated by the linear electrodes, and many others arrangements are similarly possible by adjusting the electrical parameters of the various linear electrodes 132. The illustrated arrangement can create an overall lensing effect where light emitting from the display is refracted to a gradually greater degree moving from right to the left (toward an edge of the device), such that light from the left-most part of the display 102 near the deadband region 104 (see FIG. 2) is bent to the left to a greatest degree and light emitted from the middle of the display (to the right in FIGS. 2 and 3) is minimally refracted or not refracted as it passes through the lens. This lensing effect can cause the display area to appear wider than the actual width of the display 102 and can reduce the apparent width of the deadband region 104 at the lateral edges of the device. This lensing effect can be mirrored on the opposing lateral side of the device 100 (not shown) as desired.

Various other non-illustrated lensing effects can similarly be achieved with the disclosed technology. For example, all of the liquid crystal portions can be made to be tilted in a uniform manner (constant refractive index) such that the entire display image (or a portion of it) appears to be shifted in unison over to one side, or translated, but not necessarily enlarged in size.

Moreover, the lensing effect generatable by the disclosed liquid crystal lens technology can be adjusted and controlled over time in any desired manner, rather than producing a fixed effect like a traditional glass lens having a curved surface that produces the lensing effect. For example, the lensing effect may be turned off by a user or by a computing device so that the image displayed by the display device is not distorted by the lens. Simply changing the electrical parameters of the linear electrodes can produce the desired change in the lensing effect.

In addition, the overall thickness of the liquid crystal lenses disclosed herein can be made significantly smaller than a traditional cover window that includes a curved or chamfered edge to produce an equivalent lensing effect. The reduced thickness of the liquid crystal lens can allow for a thinner overall device, or more room for other components in the device, or both. The disclosed technology also provides a smoother, flatter outer surface at the edge of the display area, compared to a cover window having a curved or chamfered edge.

The various components of the display and lens modules disclosed herein can have any reasonable dimensions, and the embodiments illustrated are not necessarily shown to scale. Some illustrated components are exaggerated in relative size for illustrative purposes, while other components are minimize or omitted. The following are non-limiting exemplary dimensions values.

The inner and outer transparent substrate layers 106 and 112 can have a thickness of from about 0.05 mm to about 0.30 mm, for example. The liquid crystal material layer 110 can have a thickness of from about 5 μm to about 0.1 mm, for example. In combination, the inner and outer transparent substrate layers and the liquid crystal material layer in between can have a total thickness of from about 0.10 mm to about 0.70 mm, such as from 0.10 mm to about 0.40 mm. The display portion 102 can have any thickness, such as from about 0.5 mm to about 1.0 mm. The adhesive layer 108 can have a thickness of from about 0.01 mm to about 0.20 mm, for example.

The deadband region 104 of the display can have a width of from about 0.01 mm to about 2.0 mm, such as from about 0.7 mm to about 0.8 mm for an exemplary OLED display. By contrast, the sealing material 114 at the lateral side of the liquid crystal material layer can be much narrower than the deadband region 104, with a width of from about 0.01 mm to about 0.5 mm, such as from about 0.2 to about 0.3 mm. This allows the liquid crystal material layer to overlap the deadband region to some extent and provides lateral space in the lens to refracting light leftward from the left edge of the display 102 (based on the orientation of FIG. 2).

In some embodiments, the liquid crystal material layer and associated electrodes can be tuned or otherwise utilized to act as a filter as opposed to, or in addition to, acting as a lens. For example, acting as a filter can include filtering out certain colors or wavelength ranges from the light passing through the lens.

In some exemplary devices, the disclosed technology can be implemented on two of more different displays (such as a one front display and one rear display), or can be implemented as to discrete lens portions over different regions of the same display (such the left and right edge of the display, top and bottom edges, all four edges, etc.). Each edge of a display device can include its own “edge lens” implementing the disclosed technology.

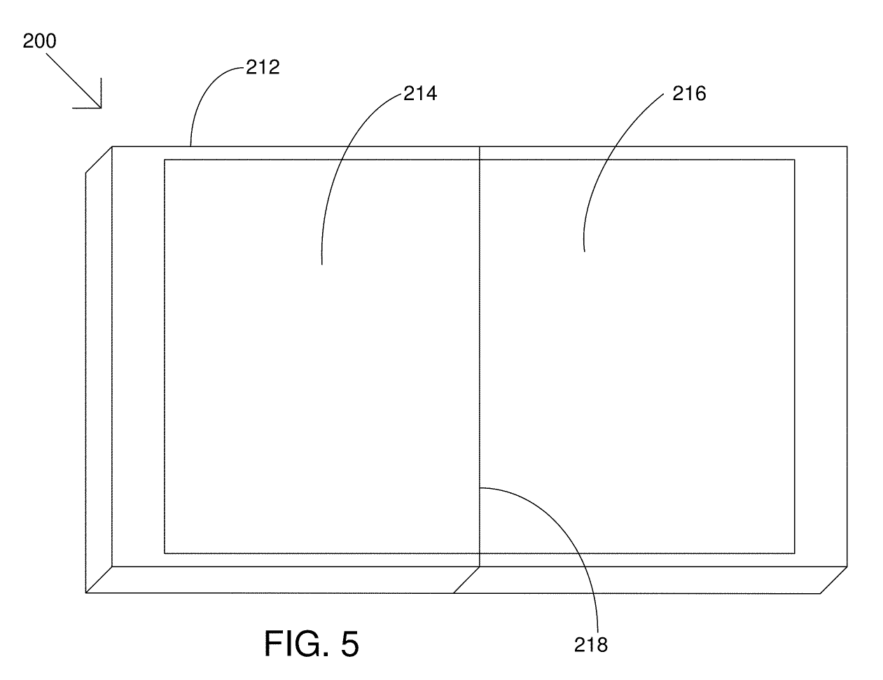

FIG. 5 shows an exemplary electronic device 200 that includes an outer frame or body 212 and two adjacent display areas 214 and 216 separated by a narrow gap 218. For example, the device 200 can comprise a multi-part device, such as a foldable device, like a hinged laptop computer or hinged/articulating mobile phone. When in the unfolded or extended state as shown, also sometimes called the open position, the two display areas 214, 216 abut each other or are close to each other, such as to effectively form one larger display area. The device 200 may also be a monolithic/non-hinged device that includes two adjacent non-movable displays. In any case, it can be desirable to minimize the apparent width of the gap 218, and the disclosed technology can help accomplish that purpose. For example, the display 214 can include a deadband area along the gap 218 and the display 216 can also include a deadband area along the gap 218, and together the two deadband areas can create an undesirably thick dark stripe down the middle of the combined display area along the gap 218. However, the disclosed technology can be provided along the edges of the displays 214 and 216 to create a lensing effect that makes the deadband areas look smaller or invisible by shifting light from the displays toward the gap 218 so that it appears to be coming from the center gap area. Accordingly, the disclosed technology can be used along edges of display areas near the edges of the device itself, near other adjacent displays, both, and/or for other lensing effect purposes.

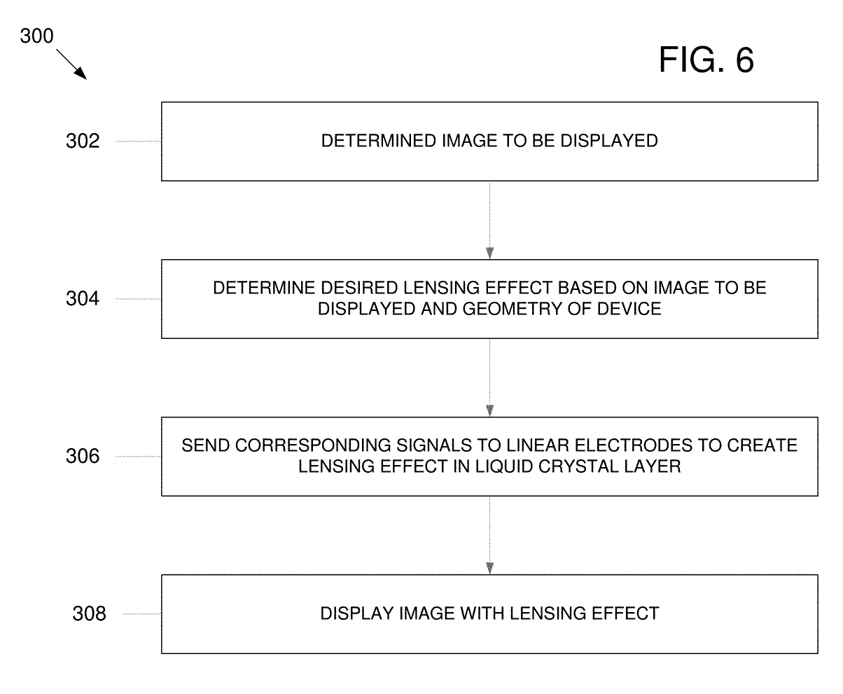

FIG. 6 is flow chart illustrating an exemplary method 300 utilizing the disclosed technology. At 302, the method can comprise initially determining an image to be displayed by an electronic display device. This can comprise, for example, selecting a still image or a video from a memory device to show with the display device. The determining step can be performed by software as a result of some input, and/or by way a user selection. In order to have the selected image appear as desired to a user on the display area (e.g., appear larger or shifted to overlap a deadband area), the image may need to be manipulated between the device that produces the image and a viewer's eyes via a lensing effect generated by the disclosed technology. At 304, the method can comprise determining a desired lensing effect to be applied based on the selected image to be displayed, the geometry of the device (e.g., the location and/or size of the deadband area). This determination can be performed by the device hardware/firmware/software based on the geometry of the device, the image to be displayed, the locations/size of the image relative to the display area, etc. At 306, the method can comprise sending corresponding electrical signals, e.g., from the device CPU or GPU, to the appropriate linear electrodes in the lens to generate the desired lensing effect in the liquid crystal layer of the lens. And, at 308, the method can comprise displaying the image with the display device such that the image is desirably manipulated by the lensing effect and provides the desired appearance to the user.

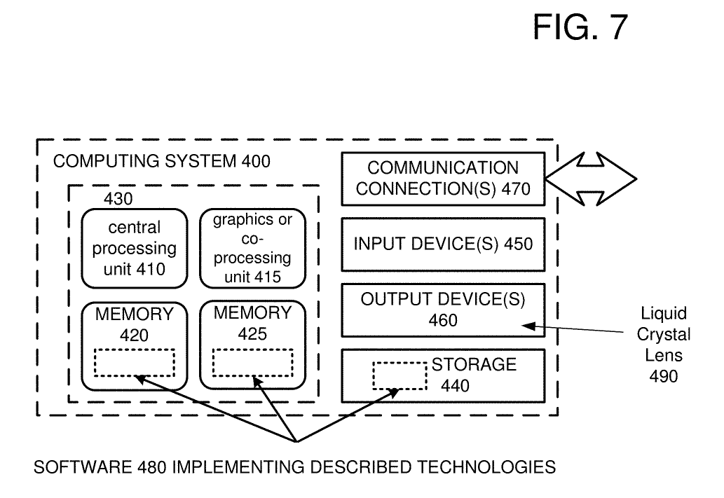

FIG. 7 depicts a generalized example of a suitable computing system 400 in which the described innovations may be implemented. The computing system 400 is not intended to suggest any limitation as to scope of use or functionality, as the innovations may be implemented in diverse general-purpose or special-purpose computing systems.

With reference to FIG. 7, the computing system 400 includes one or more processing units 410, 415 and memory 420, 425. In FIG. 1, this basic configuration 430 is included within a dashed line. The processing units 410, 415 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 7 shows a central processing unit 410 as well as a graphics processing unit or co-processing unit 415. The tangible memory 420, 425 may be volatile memory (e.g., registers, cache, RAM), non-volatile memory (e.g., ROM, EEPROM, flash memory, etc.), or some combination of the two, accessible by the processing unit(s). The memory 420, 425 stores software 480 implementing one or more innovations described herein, in the form of computer-executable instructions suitable for execution by the processing unit(s).

A computing system may have additional features. For example, the computing system 400 includes storage 440, one or more input devices 450, one or more output devices 460 (which can include the disclosed liquid crystal lens technology 490), and/or one or more communication connections 470. An interconnection mechanism (not shown) such as a bus, controller, or network interconnects the components of the computing system 400. Typically, operating system software (not shown) provides an operating environment for other software executing in the computing system 400, and coordinates activities of the components of the computing system 400.

The tangible storage 440 may be removable or non-removable, and includes magnetic disks, magnetic tapes or cassettes, CD-ROMs, DVDs, or any other medium which can be used to store information and which can be accessed within the computing system 400. The storage 440 stores instructions for the software 480 implementing one or more innovations described herein.

The input device(s) 450 may be a touch input device such as a keyboard, mouse, pen, or trackball, a voice input device, a scanning device, or another device that provides input to the computing system 400. For video encoding, the input device(s) 450 may be a camera, video card, TV tuner card, or similar device that accepts video input in analog or digital form, or a CD-ROM or CD-RW that reads video samples into the computing system 400. The output device(s) 460 may be a display, printer, speaker, CD-writer, and/or another devices that provide output from the computing system 400.

The communication connection(s) 470 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

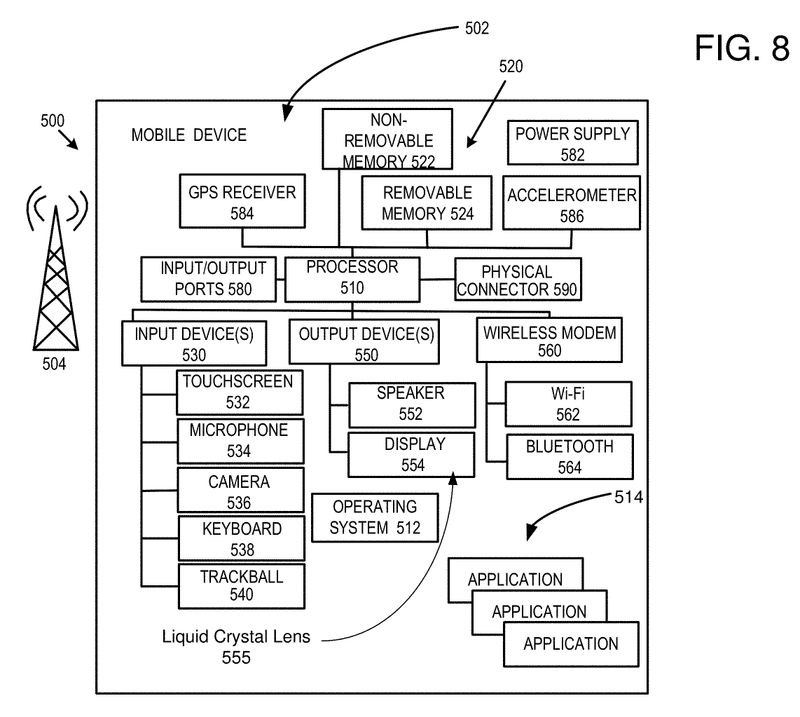

FIG. 8 is a system diagram depicting an example mobile electronic device 500, in which the disclosed technology may be incorporated, including a variety of optional hardware and software components, shown generally at 502. Any components 502 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 504, such as a cellular, satellite, or other network.

The illustrated mobile device 500 can include a controller or processor 510 (e.g., signal processor, microprocessor, ASIC, or other control and processing logic circuitry) for performing such tasks as signal coding, data processing, input/output processing, power control, and/or other functions. An operating system 512 can control the allocation and usage of the components 502 and support for one or more application programs 514. The application programs can include common mobile computing applications (e.g., email applications, calendars, contact managers, web browsers, messaging applications), or any other computing application. Functionality 513 for accessing an application store can also be used for acquiring and updating application programs 514.

The illustrated mobile device 500 can include memory 520. Memory 520 can include non-removable memory 522 and/or removable memory 524. The non-removable memory 522 can include RAM, ROM, flash memory, a hard disk, or other well-known memory storage technologies. The removable memory 524 can include flash memory or a Subscriber Identity Module (SIM) card, which is well known in GSM communication systems, or other well-known memory storage technologies, such as “smart cards.” The memory 520 can be used for storing data and/or code for running the operating system 512 and the applications 514. Example data can include web pages, text, images, sound files, video data, or other data sets to be sent to and/or received from one or more network servers or other devices via one or more wired or wireless networks. The memory 520 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 500 can support one or more input devices 530, such as a touchscreen 532, microphone 534, camera 536, physical keyboard 538 and/or trackball 540 and one or more output devices 550, such as a speaker 552 and a display(s) 554. Other possible output devices (not shown) can include piezoelectric or other haptic output devices. Some devices can serve more than one input/output function. For example, a touchscreen 532 and a display 554 can be combined in a single input/output device. The one or more displays 554 can include the disclosed liquid crystal lens technology 555, for example.

The input devices 530 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 512 or applications 514 can comprise speech-recognition software as part of a voice user interface that allows a user to operate the device 500 via voice commands. Further, the device 500 can comprise input devices and software that allows for user interaction via a user's spatial gestures, such as detecting and interpreting gestures to provide input to a gaming application.

A wireless modem 560 can be coupled to an antenna (not shown) and can support two-way communications between the processor 510 and external devices, as is well understood in the art. The modem 560 is shown generically and can include a cellular modem for communicating with the mobile communication network 504 and/or other radio-based modems (e.g., Bluetooth 564 or Wi-Fi 562). The wireless modem 560 is typically configured for communication with one or more cellular networks, such as a GSM network for data and voice communications within a single cellular network, between cellular networks, or between the mobile device and a public switched telephone network (PSTN).

The mobile device can further include at least one input/output port 580, a power supply 582, a satellite navigation system receiver 584, such as a Global Positioning System (GPS) receiver, an accelerometer 586, and/or a physical connector 590, which can be a USB port, IEEE 1394 (FireWire) port, and/or RS-232 port. The illustrated components 502 are not required or all-inclusive, as any components can be deleted and other components can be added.

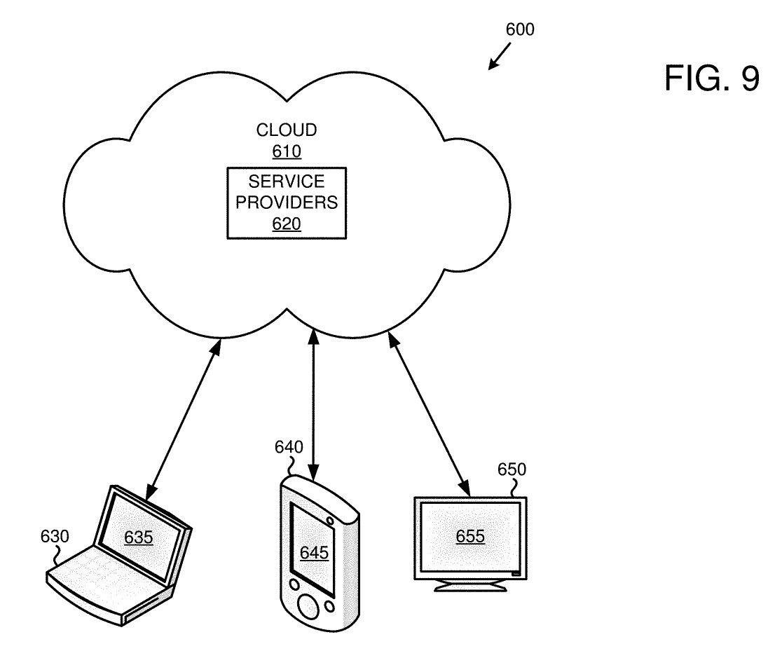

FIG. 9 illustrates a generalized example of a suitable cloud-supported environment 600 in which described embodiments, techniques, and technologies may be implemented. In the example environment 600, various types of services (e.g., computing services) are provided by a cloud 610. For example, the cloud 610 can comprise a collection of computing devices, which may be located centrally or distributed, that provide cloud-based services to various types of users and devices connected via a network such as the Internet. The implementation environment 600 can be used in different ways to accomplish computing tasks. For example, some tasks (e.g., processing user input and presenting a user interface) can be performed on local computing devices (e.g., connected devices 630, 640, 650) while other tasks (e.g., storage of data to be used in subsequent processing) can be performed in the cloud 610. Devices 630, 640, and 650 illustrate exemplary electronic devices in which the disclosed liquid crystal lens technology can be implemented.

In example environment 600, the cloud 610 provides services for connected devices 630, 640, 650 with a variety of screen capabilities. Connected device 630 represents a device with a computer screen 635 (e.g., a mid-size screen). For example, connected device 630 could be a personal computer such as desktop computer, laptop, notebook, netbook, or the like. Connected device 640 represents a device with a mobile device screen 645 (e.g., a small size screen). For example, connected device 640 could be a mobile phone, smart phone, handheld gaming controller, universal remote control, personal digital assistant, tablet computer, and the like. Connected device 650 represents a device with a large screen 655. For example, connected device 650 could be a television screen (e.g., a smart television) or another device connected to a television (e.g., a set-top box or gaming console) or the like. Any of these displays devices can be used with the disclosed liquid crystal lens technology, for example.

One or more of the connected devices 630, 640, 650 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 600. For example, the cloud 610 can provide services for one or more computers (e.g., server computers) without displays.

Services can be provided by the cloud 610 through service providers 620, or through other providers of online services (not depicted). For example, cloud services can be customized to the screen size, display capability, and/or touchscreen capability of a particular connected device (e.g., connected devices 630, 640, 650).

In example environment 600, the cloud 610 provides the technologies and solutions described herein to the various connected devices 630, 640, 650 using, at least in part, the service providers 620. For example, the service providers 620 can provide a centralized solution for various cloud-based services. The service providers 620 can manage service subscriptions for users and/or devices (e.g., for the connected devices 630, 640, 650 and/or their respective users).

The following paragraphs further describe implementations of the disclosed liquid crystal lens technology and associated electronic displays and electronic devices:

A. An electronic liquid crystal lens for use in an electronic device, comprising:

an outer transparent substrate layer;

an inner transparent substrate layer;

a layer of liquid crystal material arranged between the inner and outer transparent substrate layers; and

linear electrodes arranged between the inner and outer transparent substrate layers and aligned with the layer of liquid crystal material, the linear electrodes being controllable to achieve a lensing effect through the lens by generating a variable refractive index in the layer of liquid crystal material.

B. The lens of paragraph A, further comprising a planar electrode positioned between the inner and outer transparent substrate layers and on a side of the layer of liquid crystal material opposite from the linear electrodes.

C. The lens of any of paragraphs A-B, wherein the linear electrodes are arranged parallel to one another in a common plane

D. The lens of paragraph C, wherein the layer of liquid crystal material is planar and arranged parallel to the plane of the linear electrodes.

E. The lens of any of paragraphs A-D, wherein each of the linear electrodes is individually controllable to control the refractive index of a corresponding a linear row portion of the layer of liquid crystal material.

F. The lens of any of paragraphs A-E, wherein the linear electrodes are parallel with an edge of the outer transparent substrate layer.

G. The lens of any of paragraphs A-F, further comprising a sealing material creating a seal between the inner and outer transparent substrate layers along a lateral side of the lens to contain the liquid crystal material within the lens.

H. The lens of any of paragraphs A-G, wherein the lensing effect is capable of causing light from a display image to pass through the outer transparent substrate layer closer to a lateral edge of the lens than where the light passes through the inner transparent substrate layer.

I. The lens of any of paragraphs A-H, wherein the outer transparent substrate layer comprises a planar outer surface, a planar inner surface, planar lateral surfaces, and right-angled edges joining the lateral surfaces to the inner and outer surfaces, such that light is not refracted while passing through the outer transparent layer from the inner surface to the outer surface.

J. An electronic device comprising:

a frame;

an electronic display mounted to the frame;

and an electronic liquid crystal lens mounted external to the electronic display, the lens comprising:
an outer transparent substrate layer;
an inner transparent substrate layer;
liquid crystal material arranged between the inner and outer transparent substrate layers; and
linear electrodes arranged between the inner and outer transparent substrate layers and in contact with the liquid crystal material, the linear electrodes being controllable to achieve a lensing effect through the lens by generating a variable refractive index in the liquid crystal material.

K. The device of paragraph J, where the lens is configured to cause an edge of a display image generated by the electronic display to appear closer to an edge of the frame than an edge of the electronic display.

L. The device of any of paragraphs J-K, wherein a lateral edge of the display device is spaced a first distance from a lateral edge of the frame, a lateral edge of the lens is spaced a second distance from the lateral edge of the frame, the second distance being smaller than the first distance, such that the lens makes a display image from the display device appear closer to the lateral edge of the frame.

M. The device of any of paragraphs J-L, wherein the electronic display has a first lateral width between opposing lateral edges of the electronic display, the lens has a second lateral width between opposing lateral edges of the lens, the second width is larger than the first width, and the linear electrodes extend parallel to the lateral edges of the electronic display and parallel to the lateral edges of the lens.

N. The device of any of paragraphs J-M, wherein each of the linear electrodes is individually controllable to control the refractive index of a corresponding linear portion of the liquid crystal material.

O. A method of implementing a lensing effect, comprising:

selecting an image to be displayed in a display area of an electronic device;

determining a desired lensing effect to be applied to modify the appearance of the selected image based on a dimension of an electronic display device and a dimension of the display area;

sending electronic signals to linear electrodes in a liquid crystal material layer to generate the determined lensing effect in the liquid crystal material layer by adjusting the refractive index of the portion of the liquid crystal material adjacent to each respective linear electrode; and

displaying the selected image with the electronic display device such that the liquid crystal material layer modifies the image to produce a desired appearance of the image in the display area.

P. The method of paragraph O, wherein sending electronic signals to the linear electrodes comprises applying differing voltages to different ones of the linear electrodes to create a variable refractive index across a dimension of the liquid crystal material layer.

Q. The method of any of paragraphs O-P, wherein the lensing effect causes a deadband area of the electronic display to have a reduced apparent size in the display area.

R. The method of any of paragraphs O-Q, wherein the electronic signals cause one of the linear electrodes adjacent a lateral edge of the electronic display to cause liquid crystal molecules in the immediate vicinity to orient is such a way so as to refract light from the electronic display toward the lateral edge of the electronic display.

S. The method of any of paragraphs O-R, wherein the lensing effect causes the image to appear to have a greater size than the electronic display.

T. The method of any of paragraphs O-S, wherein the electronic device includes two adjacent display areas for two associated adjacent electronic displays, the electronic displays have adjacent deadbands, each electronic display has a respective liquid crystal material layer, and the method comprises causing the liquid crystal material layers to generate coordinated lensing effects that make simultaneously emitted images from the two electronic displays appear closer together so as to reduce the apparent width of the deadbands to a user.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

The terms “system” and “device” are used interchangeably herein. Unless the context clearly indicates otherwise, neither term implies any limitation on a type of computing system or computing device. In general, a computing system or device can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

In view of the many possible embodiments to which the principles of the disclosed technology may be applied, it should be recognized that the illustrated embodiments are only preferred examples of the disclosed technology and should not be taken as limiting the scope of the invention(s). Rather, the scope of the invention(s) is defined by the following claims. I therefore claim as my invention(s) all that comes within the scope of these claims.

1. An electronic liquid crystal lens for use in an electronic device, comprising:
an outer transparent substrate layer;
an inner transparent substrate layer;
a layer of liquid crystal material arranged between the inner and outer transparent substrate layers; and
linear electrodes arranged between the inner and outer transparent substrate layers and along with layer of liquid crystal material, the linear electrodes being controllable to achieve a lensing effect through the lens by generating a variable refractive index in the layer of liquid crystal material.

2. The lens of claim 1, further comprising a planar electrode positioned between the inner and outer transparent substrate layers and on a side of the layer of liquid crystal material opposite from the linear electrodes.

3. The lens of claim 1, wherein the linear electrodes are arranged parallel to one another in a common plane.

4. The lens of claim 3, wherein the layer of liquid crystal material is planar and parallel to the plane of the linear electrodes.

5. The lens of claim 1, wherein each of the linear electrodes is individually controllable to control the refractive index of a corresponding linear row in the layer of liquid crystal material.

6. The lens of claim 1, wherein the linear electrodes are parallel with an edge of the outer transparent substrate layer.

7. The lens of claim 1, further comprising a sealing material creating a seal between the inner and outer transparent substrate layers along a lateral side of the lens to contain the layer of liquid crystal material within the lens.

8. The lens of claim 1, wherein the lensing effect is capable of causing light from a display image to pass through the outer transparent substrate layer closer to a lateral edge of the lens than where the light passes through the inner transparent substrate layer.

9. The lens of claim 1, wherein the outer transparent substrate layer comprises a planar outer surface, a planar inner surface, planar lateral surfaces, and right-angled edges joining the lateral surfaces to the inner and outer surfaces, such that light is not refracted while passing through the outer transparent layer from the inner surface to the outer surface.

10. An electronic device comprising:
a frame;
an electronic display mounted to the frame;
and an electronic liquid crystal lens mounted external to the electronic display, the lens comprising:
an outer transparent substrate layer;
an inner transparent substrate layer;
liquid crystal material arranged between the inner and outer transparent substrate layers; and
linear electrodes arranged between the inner and outer transparent substrate layers and in contact with the liquid crystal material, the linear electrodes being controllable to achieve a lensing effect through the lens by generating a variable refractive index in the liquid crystal material.

11. The device of claim 10, where the lens is configured to cause an edge of a display image generated by the electronic display to appear closer to an edge of the frame than an edge of the electronic display.

12. The device of claim 10, wherein a lateral edge of the display device is spaced a first distance from a lateral edge of the frame, a lateral edge of the lens is spaced a second distance from the lateral edge of the frame, the second distance being smaller than the first distance, such that the lens makes a display image from the display device appear closer to the lateral edge of the frame.

13. The device of claim 10, wherein the electronic display has a first lateral width between opposing lateral edges of the electronic display, the lens has a second lateral width between opposing lateral edges of the lens, the second width is larger than the first width, and the linear electrodes extend parallel to the lateral edges of the electronic display and parallel to the lateral edges of the lens.

14. The device of claim 10, wherein each of the linear electrodes is individually controllable to control the refractive index of a corresponding linear portion of the liquid crystal material.

15. A method of implementing a lensing effect, comprising:
selecting an image to be displayed in a display area of an electronic device;
determining a desired lensing effect to be applied to modify the appearance of the selected image based on a dimension of an electronic display device and a dimension of the display area;
sending electronic signals to linear electrodes in a liquid crystal material layer to generate the determined lensing effect in the liquid crystal material layer by adjusting the refractive index of the portion of the liquid crystal material adjacent to each respective linear electrode; and
displaying the selected image with the electronic display device such that the liquid crystal material layer modifies the image to produce a desired appearance of the image in the display area.

16. The method of claim 15, wherein sending electronic signals to the linear electrodes comprises applying differing voltages to different ones of the linear electrodes to create a variable refractive index across a dimension of the liquid crystal material layer.

17. The method of claim 15, wherein the lensing effect causes a deadband area of the electronic display to have a reduced apparent size in the display area.

18. The method of claim 15, wherein the electronic signals cause one of the linear electrodes adjacent a lateral edge of the electronic display to cause liquid crystal molecules in the immediate vicinity to orient is such a way so as to refract light from the electronic display toward the lateral edge of the electronic display.

19. The method of claim 15, wherein the lensing effect causes the image to appear to have a greater size than the electronic display.

20. The method of claim 15, wherein the electronic device includes two adjacent display areas for two associated adjacent electronic displays, the electronic displays have adjacent deadbands, each electronic display has a respective liquid crystal material layer, and the method comprises causing the liquid crystal material layers to generate coordinated lensing effects that make simultaneously emitted images from the two electronic displays appear closer together so as to reduce the apparent width of the deadbands to a user.
